(19) United States
(12) Patent Application Publication
(10) Pub. No.: US 2006/0288402 A1
(43) Pub. Date: Dec. 21, 2006

(54) Security component for dynamic properties framework

(75) Inventor: Sailesh Sathish, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/157,487

(22) Filed: Jun. 20, 2005

(51) Int. Cl. H04L 9/32

(52) U.S. Cl. 726/2

(57) ABSTRACT

This invention relates to dynamic properties framework and particularly to a security framework for the dynamic properties framework. The dynamic properties framework comprises at least one property, each of which have a metadata interface for providing information of the property in question, which metadata interface comprises an owner tag and a visibility tag. A security method comprises steps for determining a class of a component and for providing said component with various rights for the property according to the class of said component as well as according to the owner and the visibility tag of said property.

### FIELD OF THE INVENTION

This invention relates to dynamic properties framework and particularly to a security framework for the dynamic properties framework.

### BACKGROUND OF THE INVENTION

Dynamic properties framework (DPF) introduces a platform and language neutral interfaces for providing to e.g. web applications access to a hierarchy of dynamic properties of a device. DPF is needed because multimodal applications are expected to function in heterogeneous environments with widely varying device capabilities. DPF provides an Interaction Manager (that coordinates data and manages execution flow from various input and output modalities) with dynamic access to the hierarchy of dynamic properties. The dynamic properties, such as for example, the device configuration, user preferences and environmental conditions can vary dynamically, and applications need to be able to respond accordingly. These dynamic properties indicate which modes of interaction are supported, which are currently active, as well as a means to enable or disable particular modes, and to get notifications when users make changes themselves.

DPF is intended to enable dynamic adaptation of the dynamic properties. By means of DPF it is possible to query properties and their values; update (run-time settable) properties; and receive notifications of properties' changes. For dynamic properties it is important to be able to respond to changes when they occur, for example, the devices' new location, consequently a mechanism to subscribe and unsubscribe to specific events is required.

Multimodal browsing enables the user to browse a multimodal page that comprises different modalities such as a graphical user interface (GUI), speech, touch, vision, etc. The processors for each modality can either reside on a client terminal or it can reside on a network. In addition to modality processors, the dialog flow can also be affected by secondary sources such as device state, network state, user preference, etc. This information can be acquired via the DPF, which can be considered to be a way for different components (programs) to access dynamic information available in the device.

Currently security related issues for the DPF framework are discussed superficially. However, for implementing a trustable security, more detailed design is needed.

### SUMMARY OF THE INVENTION

This invention aims to provide a solution for improving the security of the multimodal browsing and the security of the DPF tree. The invention aims to identify the components that are approaching the DPF tree and providing selective access to the tree. The current invention is based on a DPF hierarchy and to an existing metadata interface.

For achieving this aim a method, a structure, a device, a security module and a computer program product are provided.

In a method for security in dynamic properties framework comprising at least one property, each of which have a metadata interface for providing information of the property in question, which metadata interface comprises an owner tag and a visibility tag, said method comprises steps for determining a class of a component and for providing said component with various rights for the property according to the class of said component as well as according to the owner and the visibility tag of said property.

In a structure for a dynamic properties framework comprising properties, each of the properties have a metadata interface for providing information of the property in question, which metadata interface comprises an owner tag—for allowing components with the relative information to act with said property—and a visibility tag—for allowing said property to be seen for components.

A device for multimodal interaction comprises a dynamic properties framework and a security module for securing said dynamic properties framework, wherein the properties have a metadata interface for providing information of the property in question, which metadata interface comprises an owner tag—for allowing components having a class relating to said owner tag to act with said property; and a visibility tag—for allowing said property to be seen by the components.

A security module for dynamic properties framework, comprises means for checking each component and providing various rights to the components depending on a class of the component, and also depending an owner tag and a visibility tag of the property.

A computer program product for dynamic properties framework, comprises code means stored on a readable medium, adapted, when run on a computer, to check each component and to provide various rights to the components depending on a class of the component, and also depending an owner tag and a visibility tag of the property

According to the solution of this invention, it is possible to minimize the risk of supplying invalid or incorrect information to the calling application or of creating bogus properties within the framework by malicious programs.

### DESCRIPTION OF THE DRAWINGS

This invention is described in a more detailed manner by means of the following detailed description and with reference to following figures:

FIG. 1 illustrates an example of a DPF tree structure,

FIG. 2 illustrates an example of a system comprising DPF framework and a security module, and

FIG. 3 illustrates an example of a device according to the invention.

### DETAILED DESCRIPTION OF THE INVENTION

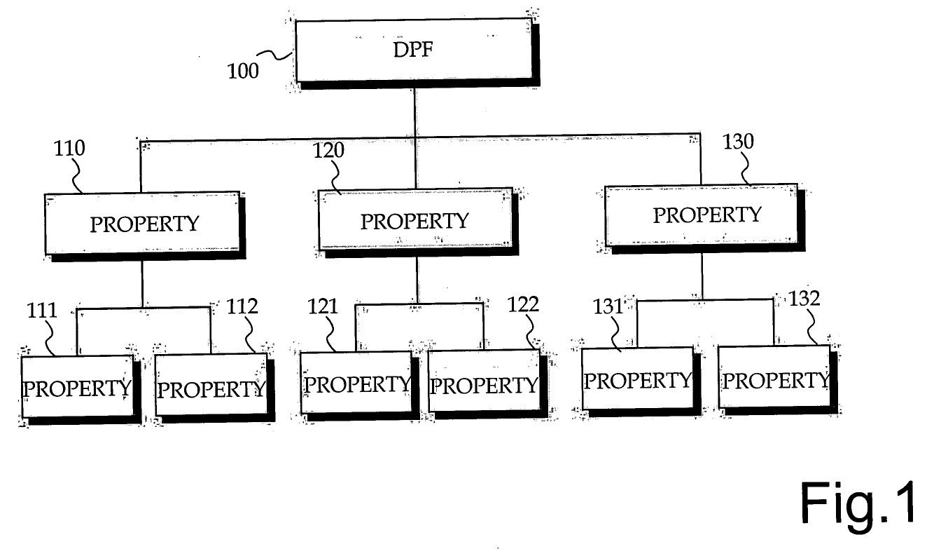

This invention provides a separate security module for the DPF framework and suggests the use of it. The security module provides security to the DPF framework as well as to the calling applications. In FIG. 1 illustrates a DPF framework, which is based on property hierarchies arranged in a tree structure. Properties 110-132 can be added to and deleted from the tree 100, and the tree comprises methods for searching and accessing values. In addition the properties comprise attributes such as value of the property the parent node of the property, a type string telling the property's type and the metadata interface attribute. The metadata interface for the property can give information about the property and (e.g. vendor specific) additional data that can be needed for the implementation. For example, metadata can contain information about the version of the property, the time of addition, property specific data such as location of the property, megapixel data for a camera, grammar support for a speech recognizer, etc.

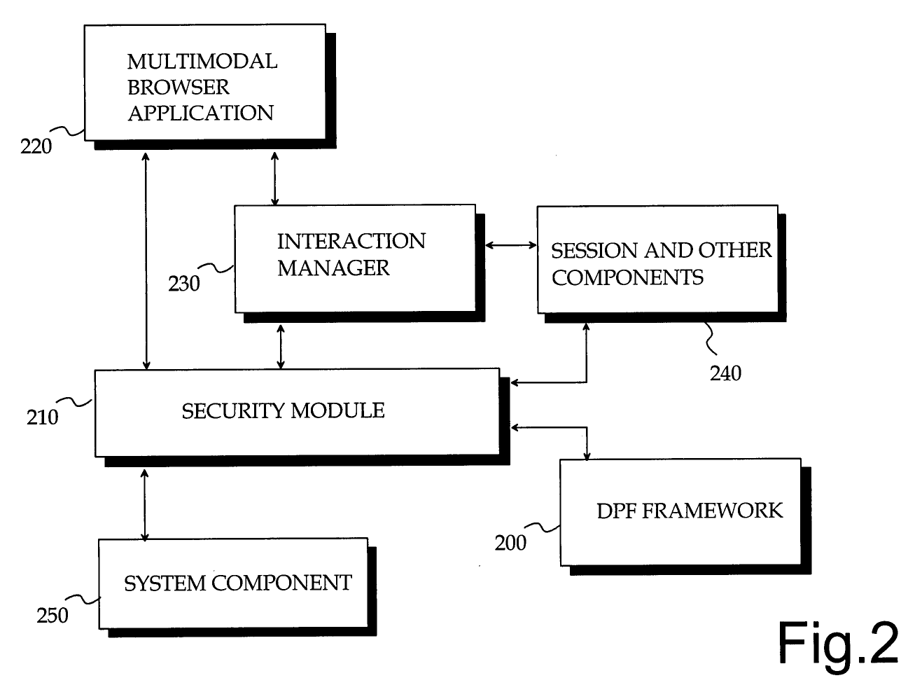

The security module 210 is illustrated in a FIG. 2 as a part of an architecture supporting the current invention. The architecture comprise multimodal browser application 220, an interaction manager 230, session components 240, system component 250 and the DPF framework 200. The security module 210 according to the invention exposes security classes which define security rights for components. Term “component” in this description refers to a software program, an application or a physical component. The components need to register to one of the classes according to a class identifier, which is assigned to the components by an operating system or a middleware component. The class identifier is generated in such a way that one part of the identifier will determine which class is in question, and the other part of the identifier uniquely identifies the component or application within said class. The class identifiers are used to determine which class the programs can be registered to. The components will register to one of these classes based on their priority (class identifier), which is assigned to them. The security component will register them to the appropriate class, and an interface for DPF corresponding to the class will be exposed to the registering component. Each of the classes can have an associated schema that can override the default behavior. The schema will be maintained by the security component and each interaction request will be validated against the schema before processing. The schema can be edited by the user, operating system or classes with the highest priority.

This invention introduces new tags for the metadata interface of the property. One tag is for “Owner” of the property, and the other is for “Visibility”. The owner of the property is identified through the owner identifier in the metadata interface. The owner entry is added by the DPF implementation platform and the entry corresponds the class identifier assigned to the component. This means that a component can create a DPF node object for itself and add it to the tree. By doing so, the DPF platform checks the component in question, adds the owner tag to the component and assigns default security settings applying that particular class. Default settings can be overridden by the owner. Priority classes can have the power to read and delete any property that is deemed to be unneeded.

The visibility tag can be set to the metadata interface by the owner of a property or a priority class. The visibility tag defines whether the property is seen by components. By setting the visibility tag to “OFF”, NO” or other negative expression, the property in question will not be visible to other components. It is also possible to set visibility for particular components based on class identifiers if the class identifiers are known. The visibility may be hierarchical in nature so that setting a visibility at a particular node would also apply to all children of that node. However, the setting will not apply to siblings of that node.

In this example the security model exposes four classes—e.g. Class A, Class B, Class C, Class D—but it will be understood that other number of classes is possible. In addition, new classes can be added whenever that is needed.

Class A:

Components that are registered to Class A have the ultimate control in the system and are so called “priority class components”. The components of Class A can add, delete, modify or replace properties and parameters of properties anywhere in the DPF tree. Visibility tags do not apply to Class A components. The properties cannot set individual class identifiers if those class identifiers belong to Class A. The security module according to the invention can be implemented so that only the operating system can add Class A components, whereby any component can not register by itself for this class. An example of a Class A component is a System component or an Interaction Manager for a multimodal system. Only a Class A component can delete a property created by another Class A component.

Class B:

Components that are registered to Class B can add new properties and are allowed to add subproperties as children to the newly added properties. Class B components can modify, delete, add and replace only those properties that were created by that particular component and those Class C type properties whose security settings are default. No other properties, such as Class B entries that are not owned by that particular component, can be modified. All registered components can access the newly added properties and register event handlers for property updates. Class B component can add to any properties within the hierarchy tree within the constraints applied as dictated by the hierarchy (e.g. a GPS property cannot be added under a video property). A Class B property can also set the visibility tag for any property created by any Class B component for class C and class D categories (all Class B settings remain the same) but not for Class B unless the owner is setting the visibility.

Class C:

Components that are registered to Class C can create DPF nodes but they can modify only those that they have created. For such properties, Class C component can set visibility for Class B, Class C and Class D categories. If a visibility has been set to OFF (other than default) for Class B category, a class B type property cannot add a new entry under class C type property. If the visibility is ON, then a Class B can add a child to Class C property but after that, the visibility of that Class C property cannot be modified by any property other than a Class A property or until the class B property that was added is removed. Class C components can register for property updates anywhere within the DPF tree.

Class D:

Class D category is applied with the highest security settings. The components registered under this category have the least priority and access rights. Class D components get only a partial view of the DPF tree, which means that such components can only read data from the DPF for which the visibility is ON. They cannot add, delete, modify or replace any entry within the DPF tree. Class D can be used for blocking user specific details such as personal codes, preferences etc. from malicious applications. The extent of blocking can be governed by the operating system as well as customized by advanced users.

In this solution, once the aforementioned settings have been done, there is a schema associated with each class, where the visibility of each property node for that class is listed. When a property belonging to a particular class tries to access the DPF tree, the schema for that class is consulted and a view corresponding to that class is created. In this view, all the properties that have visibility are added and all those whose visibility is OFF are not added. Thus there will be same amount of views that are classes, a view per class. Depending on the class identifier, further refinement of visibility is possible where a secondary schema or mask is applied after applying the class schema to the DPF tree. Hence there can be a DPF tree which would be a master repository and subsets of that tree corresponding to each class.

The default behavior of security class is that when a component creates a DPF object into the DPF tree, the security settings that is default for that component class and visibility ON for higher class comes into effect. The owner can turn the visibility off for classes B, C and D, if it is desired, or can turn off visibility for specific class identifiers. It should be noted that if there exists a child property that belongs to a higher class than the parent property, the parent property owner cannot turn the visibility of that property (parent property) OFF.

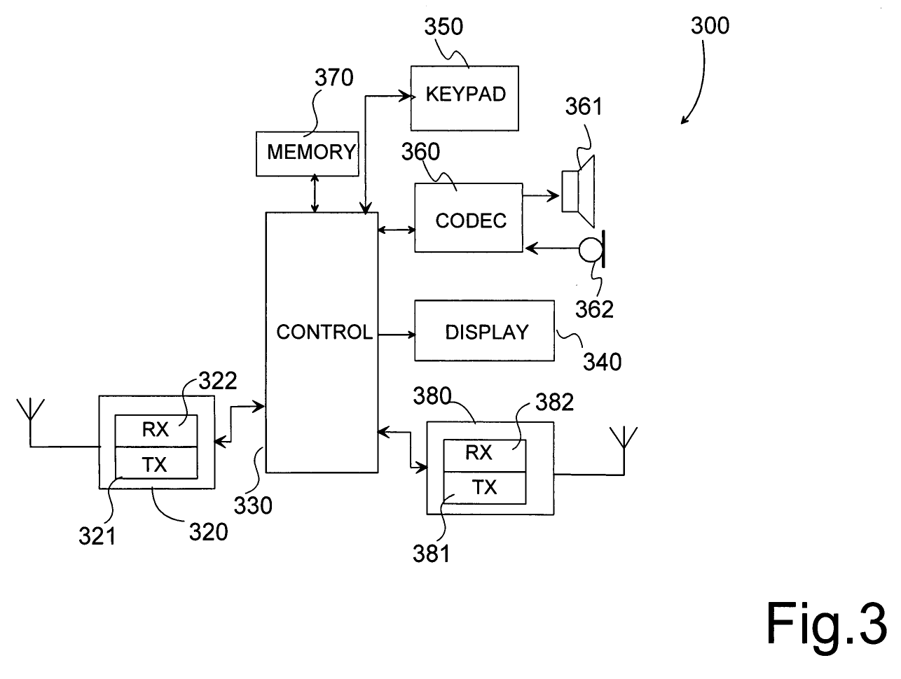

FIG. 3 illustrates an example of a device having the dynamic properties framework with security module as illustrated by the system of the FIG. 2. The device 300 comprises a communication means 320 having a transmitter 321 and a receiver 322 or be connected to such. There can also be other communicating means 380 having a transmitter 381 and a receiver 382. The first communicating means 320 can be adapted for telecommunication and the other communicating means 380 can be a kind of short-range communicating mean suitable for local use and for communicating with another device. The device 300 according to the FIG. 3 also comprises a display 340 for displaying visual information. In addition the device 300 may comprise an interaction means, such as a keypad 350 for inputting data etc. In addition or instead of the keypad 350, the device can comprise a stylusin a case where the display is a touch-screen display. The device 300 can also comprise audio means 360, such as an earphone 361 and a microphone 362 and optionally a codec for coding (and decoding, if needed) the audio information. The device 300 also comprises a control unit 330 for controlling functions and running applications in the device 300. The control unit 330 may comprise one or more processors (CPU, DSP). The device further comprises memory 370 for storing e.g. data, applications, and computer program code.

The invention has been described by means of a particular example. However, a skilled person will appreciate that variations and modifications of the examples are possible without departing from the scope of protection of the invention as set forth in the claims.

What is claimed is:

1. A method for security in a dynamic properties framework comprising at least one property, each of which have a metadata interface for providing information of the property in question, which metadata interface comprises an owner tag and a visibility tag, said method comprising steps for
determining a class of a component and
providing said component with various rights for the property according to the class of said component as well as according to the owner and the visibility tag of said property.

2. The method according to claim 1, wherein properties with a positive visibility are shown to said component.

3. The method according to claim 1, wherein said component is allowed to act with said property depending on whether the class of the component relates the owner of the property.

4. The method according to claim 1, wherein a component of a priority class is allowed to act with properties of every class.

5. The method according to claim 4, wherein a component of a priority class is allowed to delete, modify, add and replace properties in said dynamic properties framework.

6. A structure for a dynamic properties framework comprising properties, wherein each of the properties have a metadata interface for providing information of the property in question, which metadata interface comprises an owner tag—for allowing components with the relative information to act with said property—and a visibility tag—for allowing said property to be seen for components.

7. A device for multimodal interaction comprising a dynamic properties framework and a security module for securing said dynamic properties framework, wherein the properties have a metadata interface for providing information of the property in question, which metadata interface comprises an owner tag for allowing components having a class to said owner tag to act with said property; and a visibility tag—for allowing said property to be seen by the components.

8. The device according to claim 8, wherein said security module is arranged to check each component providing various rights depending on a class of the component, and also depending the owner tag and the visibility tag of the property.

9. The device according to claim 8, wherein said security module is arranged to provide full rights for priority class components.

10. The device according to claim 8, wherein said security module is arranged to provide rights to act with said property depending on whether a certain component has created said property.

11. A security module for dynamic properties framework comprising means for checking each component and providing various rights to the components depending on a class of the component, and also depending an owner tag and a visibility tag of the property.

12. The security module according to claim 12, being further arranged to provide full rights for priority class components.

13. The security module according to claim 12, being further arranged to provide rights to act with said property depending on whether a certain component has created said property.

14. A computer program product for dynamic properties framework comprising code means stored on a readable medium, adapted, when run on a computer, to check components and to provide various rights to the components depending on a class of a component, and also depending an owner tag and a visibility tag of a property.
